(19) United States
(12) Patent Application Publication
(10) Pub. No.: US 2010/0116795 A1
(43) Pub. Date: May 13, 2010

(54) APPARATUS FOR CUTTING AND/OR SHEARING FIBRE

(75) Inventor: Antony Dodworth, Lincolnshire (GB)

Correspondence Address: SALTER & MICHAELSON;THE HERITAGE BUILDING, 321 SOUTH MAIN STREET, PROVIDENCE, RI, 029037128, US

(73) Assignee: BENTLEY MOTORS LIMITED, Cheshire (GB)

(21) Appl. No.: 12/515,304

(22) PCT Filed: Nov. 16, 2007
(86) PCT No.: PCT/GB07/04388

§ 371 Date: Jan. 13, 2010

(30) Foreign Application Priority Data
Nov. 18, 2006 (GB) 0623046.0

(51) Int. Cl. B23K 26/00; B26D 7/06

(52) U.S. Cl. 219/121.67; 83/436.6

(57) ABSTRACT

Apparatus for cutting and/or shearing elongate lengths of fibre into shorter lengths has two adjacent rollers (7) and (8), and means for supplying an elongate length of fibres to the rollers. The rollers (7) and (8) are disposed in a housing (1) and define a nip therebetween. One roller (7) is a pressure roller and the other a blade housing roller. Blades are advanced through slots in the housing of the blade housing roller (8) to cut fibre into shorter lengths and projected towards a delivery slot. Air jets through apertures (20 and 21) in the wall of housing (1) guide shorter fibres out of the housing.

The present invention relates to apparatus for cutting and/or shearing elongate lengths of fibre.

The apparatus is particularly, but not exclusively intended for cutting elongate lengths of fibre into predetermined shorter lengths and applying them in controlled alignment to a mould tool.

The apparatus is particularly, but not exclusively, for use in the production of a structural product. Such products may, for example, be structural components for use in the automobile or other industries. The material to be used in the apparatus is advantageously carbon fibre, but other suitable fibres may be used. Carbon fibre has the advantage that it combines high strength with light weight. In a known method for producing structural components, a carbon fibre matt is produced. This matt comprises a multiplicity of carbon fibres aligned in the direction in which the maximum strength of the component is desired. The matt may be woven or non-woven. In the former, wefts maintain fibre warps aligned and in the latter the aligned fibres may be maintained in position by transverse extending fibres wrapped around the aligned fibres. The carbon fibre matt so produced, or “pre-preg” as it is sometimes called, is cut to the desired shape and then laid in the mould. Resin is applied and subsequently cured to produce the moulded product to the desired shape. The initial step of producing the matt and then cutting to shape is wasteful in time, energy and materials. It is an object of the invention to eliminate or mitigate these disadvantages.

According to the present invention there is provided apparatus for cutting and/or shearing elongate lengths of fibre into shorter lengths comprising two adjacent rollers, means for supplying an elongate length of fibre to the rollers, and cutting means associated with the rollers for cutting the elongate length of fibre into shorter lengths.

In a preferred embodiment of the invention, the means for supplying an elongate length of fibre comprises a housing in which the two adjacent rollers are preferably disposed. Advantageously, one of the rollers comprises a resilient surface. Preferably the resilient surface is made from rubber or other suitable material. The cutting means advantageously comprise at least one knife blade.

The or each blade is preferably retained in a roller blade housing advantageously made from hard, but resilient material such as rubber. Preferably a cam is provided to extend the or each knife blade beyond the outside surface diameter of the roller blade housing. When the cam has passed the blade the resilience of the rubber of the housing allows the blade to return to its retracted and inoperative position. Advantageously, where there is a plurality of blades a corresponding plurality of slots are formed in the blade housing roller through which respective knife blades can be extended by means of the cam. Preferably the cam is driven by means of a camshaft between operative cutting, and inoperative retracted positions. Advantageously, the camshaft is driven by means of a stepper motor that can be driven at different speeds. In an alternative, the cutting means may comprise a laser. As the fibre is cut/sheared, the rollers project the sheared fibres towards the delivery slot.

Air jet apertures preferably extend through the wall of the housing. In one preferred arrangement there are four air jet apertures, two near to the rollers and two near to the delivery slot. Those near the rollers are activated as trailing elements relative to the movement of the robot head and those near to the slot are activated on the leading face of motion.

The air jets nearest to the rollers are used to spread the shorter length fibres. This spreading action starts whilst the fibres are still partially retained by the rollers and prior to them being cut and free from the roller nip.

The air jet apertures nearest to the delivery slot are operated to admit air to rotate and align the shorter length fibres within the delivery slot/outlet from the housing.

In order that the invention may be more clearly understood, one embodiment thereof will now be described, by way of example with reference to the accompanying drawings in which:-

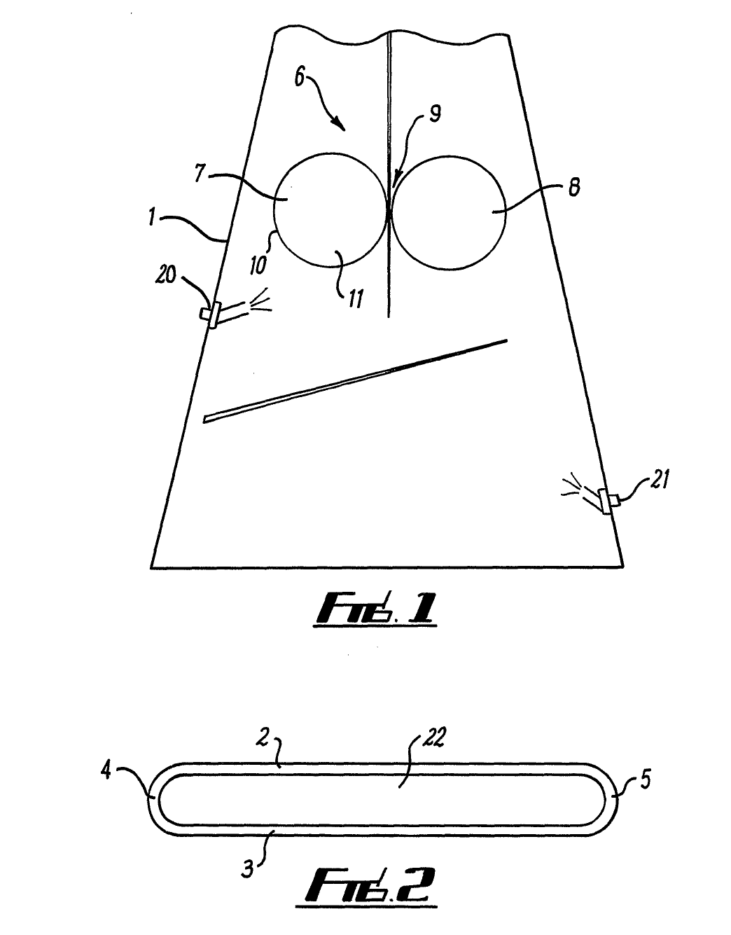

FIG. 1 shows a diagrammatic side elevation view in section of one form of the apparatus according to the invention with the delivery slot in the lowest vertical position. For simplicity only one set of air outlet jets are shown and in the correct relationship relative to the motion of the robot head.

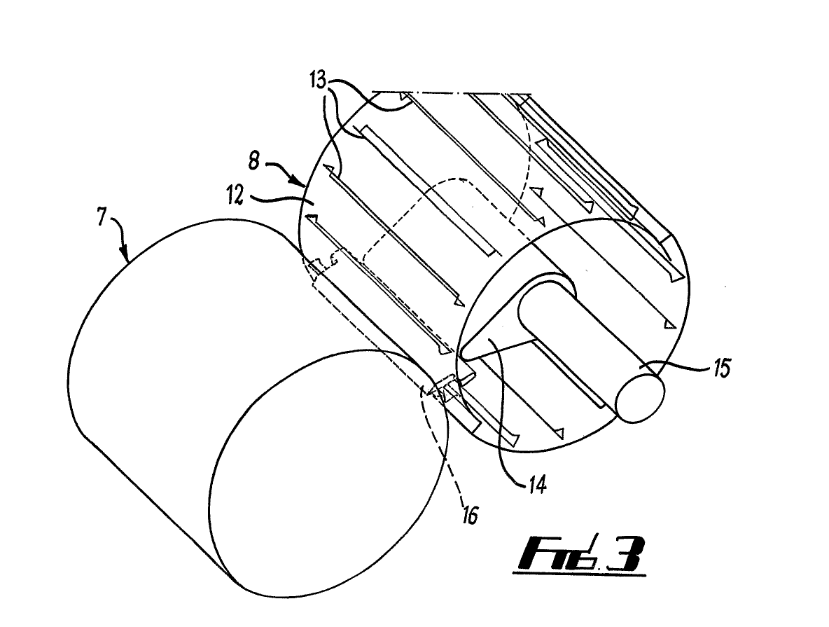

FIG. 2 is a diagrammatic underplan view of the apparatus; and

FIG. 3 is a perspective view to a larger scale of part of the apparatus of FIGS. 1 and 2.

Referring to FIGS. 1 to 3 of the drawings, the apparatus comprises a housing 1. This is shown as a downwardly divergent shape in side elevation and a lozenge shape in cross section (as can be seen from FIG. 2). The proportions of the housing 1 contribute to the consistent and smooth distribution of shortened fibres. The lozenge shape outlet/delivery slot in cross section (as shown in FIG. 2) determines the principal alignment of the alignment of the shortened fibres when deposited into the mould tool. The lozenge shape comprises two parallel sides 2 and 3 joined at opposite ends respectively by semi-circular portions 4 and 5. A cutting/shearing head 6 is disposed within the housing 1. The head 6 comprises two rollers 7 and 8 defining a nip 9 therebetween.

Roller 7 is a pressure roller and comprises a cylindrical tyre 10 mounted on a cylindrical support 11. The tyre is made of rubber or other suitable material.

Roller 8 is a blade housing roller. This comprises a cylindrical housing 12. Blades are retained in the blade housing roller 8 which is made from hard but resilient material such as rubber The diameter of the two rollers 7 and 8 is the same. Housing 12 is formed with a number of through elongate slots 13 extending axially of the cylinder of the housing and disposed at circumferentially spaced intervals around the cylinder. Disposed within the housing 12 is a cam 14 mounted on a camshaft 15 via splines (not shown). The camshaft is disposed to be driven by a stepper motor (not shown) at one of a range of speeds.

A plurality of blades 16 (only one shown) is associated with respective slots 13, and are disposed to be extended through their corresponding slots 13 sequentially by the action of the cam as it is rotated within the housing 8 by means of the camshaft 15 driven by the stepper motor in order to cut/shear fibre passing through the nip formed between the rollers 7 and 8. When the cam has passed each blade the resilience of the rubber of the housing 8 allows that blade to return to its retracted inoperative position. In this particular case there are sixteen slots 13 disposed at 22.5 degree intervals around the circumference of the housing 8 and sixteen blades respectively associated therewith. However, the number of slots 13 and blades 16 may be varied as desired. The cam lift provided by the cam 14 is circa 2 to 3 mm but again this may be varied as desired. The diameter of the rollers 7 and 8 is circa 30 mm but this may also be varied as desired. In this particular example the cam has a single lobe but multi lobe cam may be used if shorter fibre lengths are desired.

Typically for fibres that are circa 1 mm thick the cam lift for the cutting blade must be sufficient to cut through the fibre and have accommodation of circa 0.2 mm in the pressure roller (7).

The centres of rotation for rollers (7) and (8) can be adjusted so that the nip on the chosen fibre diameter is adequate to ensure consistency and meet the cutting control criteria described above.

In operation the rollers 7 and 8 are driven at the same speed which is independent of the camshaft speed. The circumferential speed of the surfaces of the rollers determines the rate of feed of fibre fed through them. By altering the speed of the stepper motor driving the camshaft 15 relative to the speed of the rollers 7 and 8, the precise length of fibre fed between the rollers and cut/sheared by the cam actuated blades extending through their corresponding slots is determined. As the fibre is cut/sheared, the rollers 7 and 8 project the shortened lengths towards the delivery slot. In the particular orientation shown where the slot is in a lower position than the rollers 7 and 8 gravity will also assist. However, the slot could be higher than the rollers 7 and 8. Shortened fibres produced by the cutting/shearing rollers 7 and 8 fall under gravity towards the base of the housing under the action of gravity. Their passage is influenced by air jets emanating from four air jet apertures extending through the wall of the housing 1 and arranged in two pairs 20 and 21 disposed respectively in the upper and lower parts of the housing 1. Only one aperture of each pair is shown.

Apertures 20 are disposed slightly below the level at which the shortened lengths of fibre are projected from between the rollers 7 and 8. The air jets through apertures 20 are activated as trailing elements relative to the movement of the robot head and the air jets through the apertures 21 are activated on the leading face of motion. The purpose of the air jets through apertures 20 is to spread the lengths of fibre. This spreading action starts whilst the fibres are still partially retained by the rollers and prior to them being cut and free from the roller nip and projected towards the delivery slot. Apertures 21 are disposed at a lower level than apertures 20. The purpose of the air jets through apertures 21 is to rotate and align the shortened lengths of fibre to the direction of and within an outlet slot 22 which is defined between parallel walls 2 and 3. The size of slot 22, the distance between the rollers 7 and 8 and the slot 22, and the air pressure of the jets through the apertures 20 and 21 are adjusted to suit the fibre length and optimize the desired fibre distribution.

It will be appreciated that the above embodiments has been described by way of example only and that many variations are possible within the scope of the invention. For example, instead of having extendable blades, the cutting means could be a laser.

1. Apparatus for cutting and/or shearing elongate lengths of fibre into shorter lengths comprising two adjacent rollers, means for supplying an elongate length of fibre to the rollers, and cutting means associated with the rollers for cutting the elongate length of fibre into shorter lengths.

2. Apparatus as claimed in claim 1, in which the means for supplying comprises a housing in which the rollers are disposed.

3. Apparatus as claimed in claim 2, in which one of the rollers comprises a resilient surface.

4. Apparatus as claimed in claim 3, in which the resilient surface is made from nibber.

5. Apparatus as claimed in claim 4, in which the other roller comprises a blade housing roller.

6. Apparatus as claimed in claim 5, in which the housing of the blade housing roller defines one or more slots through which one or more blades may be respectively extended and retracted.

7. Apparatus as claimed in claim 6, in which a cam is provide to advance the or each blade through the or each respective slot.

8. Apparatus as claimed in claim 7, in which a camshaft is provided for driving the cam between an inoperative position and an operative cutting position.

9. Apparatus as claimed in claim 8, in which the camshaft is driven by a stepper motor.

10. Apparatus as claimed in claim 9, in which the stepper motor may be driven at different speeds.

11. Apparatus as claimed in claim 5, in which the blade housing roller is made from a hard resilient material which allows a blade to be retracted after being extended from the roller.

12. Apparatus as claimed in claim 11, in which the hard resilient material is rubber.

13. Apparatus as claimed in claim 1, in which the cutting means are laser cutting means.

14. Apparatus as claimed in claim 2, in which one or more air jet apertures extend through the housing operative to guide fibre.

15. Apparatus as claimed in claim 14, in which at least one aperture is disposed below the outlet from the rollers.

16. Apparatus as claimed in claim 14, in which at least one aperture is disposed above an outlet from the housing.

17. Apparatus as claimed in claim 14, in which there are two apertures disposed below the outlet from the rollers.

18. Apparatus as claimed in claim 14, in which there are two apertures disposed above an outlet from the housing.

19. Apparatus as claimed in claim 14, in which the rollers are operative to project cut fibre towards the outlet from the housing.
